(19) United States
(12) Patent Application Publication
(10) Pub. No.: US 2017/0073185 A1
(43) Pub. Date: Mar. 16, 2017

(54) CALL PANEL AND METHOD FOR MANUFACTURING A CALL PANEL

(71) Applicant: KONE Corporation, Helsinki (FI)

(72) Inventor: Ilpo HAIPUS, Nummela (FI)

(73) Assignee: KONE Corporation, Helsinki (FI)

(21) Appl. No.: 15/359,318

(22) Filed: Nov. 22, 2016

Related U.S. Application Data
(63) Continuation of application No. PCT/FI2015/050409, filed on Jun. 10, 2015.

(30) Foreign Application Priority Data
Jun. 17, 2014 (FI) 20145571

(51) Int. Cl. B66B 1/46; B33Y 80/00; B33Y 10/00; G09B 21/00; B29C 67/00

(52) U.S. Cl. CPC B66B 1/463; G09B 21/003; B29C 67/007; B33Y 10/00; B33Y 80/00; B66B 2201/4615; B66B 2201/4623; B66B 2201/463; B29K 2105/0032

(57) ABSTRACT

A call panel of an elevator system includes at least one touch-sensitive display. On the surface of the touch-sensitive display are embossed marks, e.g. Braille characters, and embossed lines connecting them, as well as function buttons associated with the embossed marks.

The present invention relates to the call panels of elevators. More particularly the invention relates to a call panel having a touch-sensitive display and to a method for manufacturing said call panel.

### BACKGROUND OF THE INVENTION

Elevator systems are needed in buildings to a constantly increasing extent for transporting people from one floor to another. To obtain elevator service a passenger gives in the waiting lobby a landing call or a destination call to the elevator system using the pushbuttons or a special call panel in the waiting lobby. When the elevator car serving the call arrives at the floor from which the call was given, the door of the elevator car opens to allow passengers into the elevator car. If the call was given as a landing call with conventional up/down pushbuttons, the passenger must press in the elevator car the floor pushbutton in the car panel of the floor to which he/she is traveling. If, on the other hand, a call was given as a destination call with a special destination call panel, the passenger does not need to indicate his/her destination floor in the elevator car because a destination call comprises information about the passenger's destination floor as well as about the departure floor. In order for a visually impaired person to give destination calls, the destination call panel must be provided with means that can facilitate call-giving by a visually impaired person or that can make call-giving generally possible for him/her. One solution, among others, has been developed for visually impaired people wherein the destination call panel is provided with a special visual impairment pushbutton, pressing which activates a voice-guided call-giving mode. In the call-giving mode in question (visual impairment mode), the call panel auditively lists for the passenger the consecutive floor numbers, e.g. “one”, “two”, “three”, et cetera. When the listing is at the point of the floor desired by the visually impaired person, e.g. at “three”, he/she again presses the visual impairment pushbutton, from which a destination call to floor 3 is registered in the elevator system. The call-giving method described is, however, slow and is not suited to e.g. visually impaired people who are also deaf. In solutions intended for visually impaired people who are deaf, the call panel is provided with e.g. destination call buttons having e.g. Braille characters (Braille tactile writing system) to indicate the destination floor of a pushbutton. The call panels, however, easily become large and expensive because there must be a mechanical pushbutton in the call panel for each floor served by the elevator system.

Nowadays touch-sensitive displays are used in call panels to a constantly increasing extent. One advantage, among others, of them is that their functionality and graphical appearance can be configured with software to be suited to different operating situations. Call panels having a touch-sensitive screen are not, as such, suited for use by visually impaired people nor by visually impaired people who are deaf, but instead e.g. a dedicated call panel for call-giving must be arranged for them, owing to which the elevator system becomes complex and expensive.

### AIM OF THE INVENTION

The aim of the present invention is to eliminate or at least to alleviate the drawbacks presented above that occur in solutions according to prior-art. The aim of the invention is also to achieve one or more of the following objectives:
a call panel that both visually impaired people and sighted people can use,
a call panel that is easily configured and personalized

### SUMMARY OF THE INVENTION

The present invention discloses a call panel of an elevator system, the call panel comprising at least one touch-sensitive display. On the surface of the touch-sensitive display is a plurality of marks that are embossed (embossed marks), e.g. Braille characters, line elements (embossed lines) connecting the embossed marks, and also function buttons associated with the embossed marks. A call panel can be a destination call panel in an elevator lobby or a car panel in an elevator car. The function buttons are e.g. call-giving pushbuttons functioning by touch. By following the embossed lines with his/her fingertip, a visually impaired person easily finds the embossed marks on the call panel and the function buttons associated with them.

In this context embossed marks refer to one or more consecutive embossed marks, e.g. a Braille character or other mark or symbol to be identified by feeling with fingertips. In this context embossed line refers to either a continuous line, or one formed by a dashed line, that can be identified by feeling with fingertips.

In one embodiment of the invention in at least one corner of the call panel is the starting point of at least one embossed line, by following which embossed line the embossed marks on the touch-sensitive display can be found. Since the starting point of the embossed line is in a known location, a visually impaired person finds the starting point easily.

In one embodiment of the invention the function buttons associated with the embossed marks are essentially above the corresponding embossed marks. As a result of the embodiment, a visually impaired person easily finds a function button associated with embossed marks, by touching or pressing which function button he/she can activate the function indicated by the embossed mark(s).

In one embodiment of the invention the call panel comprises embossed Braille characters (symbols) 0, 1, 2 . . . 9 for finding destination call pushbuttons (function buttons) 0, 1, 2 . . . 9, by means of which a visually impaired person can give a destination call to the floor he/she wants.

In one embodiment of the invention the call panel comprises one or more personalized function buttons, associated with which is one or more embossed marks. A personalized function button refers in this context to building-specific/floor-specific function buttons. As a result of the embodiment, also a visually impaired person easily finds function buttons that are building-specific or even floor-specific.

In one embodiment of the invention the touch-sensitive display of the call panel can be easily detached and replaced with another without breaking the fixing elements of the touch-sensitive display. As a result of the embodiment, the touch-sensitive display and the embossing on it is easy to replace with a new one if changes to the embossing and/or to the function buttons and/or to their location are desired. A new embossing can be pre-printed at the factory for the touch-sensitive display and the touch-sensitive display already installed in the call panel can be replaced in situ at the installation site.

The present invention also discloses a method for manufacturing a call panel of an elevator system, the call panel comprising at least one touch-sensitive display. According to the method a plurality of embossed marks, e.g. Braille characters, and of embossed lines connecting them are printed with a 3D printer onto the surface of a touch-sensitive display according to the desired layout. As a result of the method a call panel can be manufactured quickly and can be provided with any desired layout whatsoever. It is even possible that the end customer creates a file specifying the layout, and delivers it to the manufacturer making the embossed touch-sensitive display.

In one embodiment of the invention ink cured with UV light is used in the embossings. The embossings obtained are wear resistant and they can, if so desired, be color-coded for sighted users.

With the solution according to the invention, call panels that both visually impaired and sighted persons can use can easily be manufactured. The layout of the embossing to be used on a call panel can be freely designed to be as desired, and modifying it if necessary is easy. Modifying the layout can be done in call panels that are already in use by replacing the embossed touch-sensitive display with a new one that has new embossing. Since the layout can be freely designed, even to be specific to a certain floor, call panels can be made easy to use from the viewpoint of visually impaired users, which speeds up call-giving and travel in general.

### LIST OF FIGURES

FIG. 1 presents a call panel according to the invention.

### DETAILED DESCRIPTION OF THE INVENTION

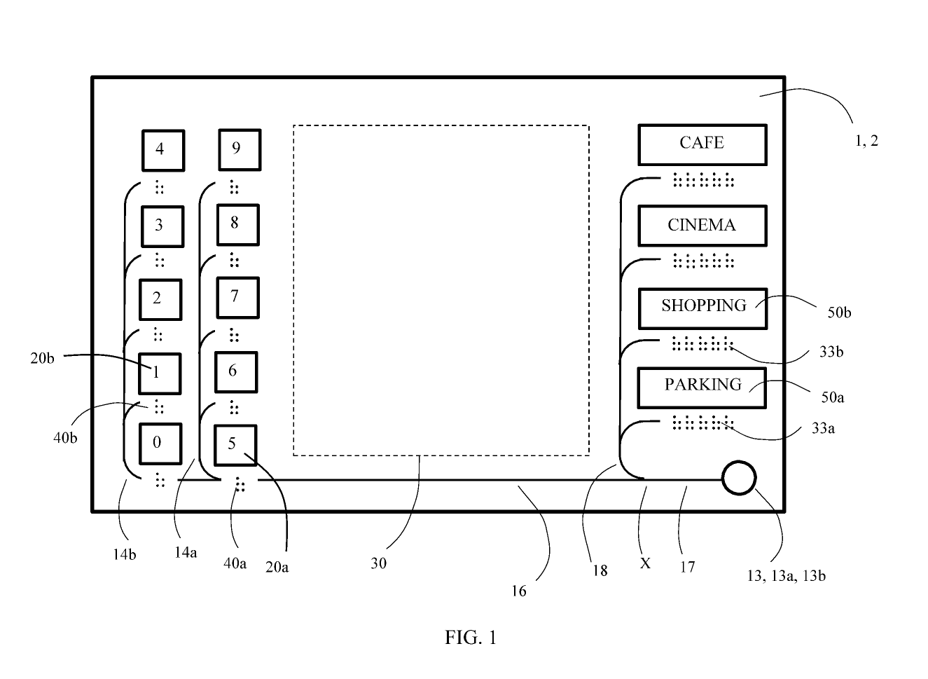

FIG. 1 presents a call panel 1 according to the invention, which is connected to the control system of an elevator system via a data transfer connection (not presented in FIG. 1) that is suited to the purpose. The call panel 1 comprises a touch-sensitive display 2, onto the surface of which embossings have been printed with a 3D printer, such embossings being e.g. embossed lines 16, 17, 18, 14 (14a, 14b) and embossed marks 33, 40 (33a, 33b, 40a, 40b). The call panel is fixed e.g. to the wall of the waiting lobby or of the elevator car or is on a pedestal in the waiting lobby.

Marked with the reference number 13 is a circle that comprises a circle element 13a (an embossed circle) as an embossing. The circle 13 is situated on the bottom right-hand side of the touch-sensitive display, where a visually impaired person can find it easily. From the circle 13 embossed lines 17, 16 lead to the Braille character “5”, which is marked in FIG. 1 with the reference number 40a. The function button “5” (marked with the reference number 20a) is associated with the Braille mark. The embossed lines 14a and 14b leave from the Braille character 40a. By following the embossed line 14a a visually impaired person can find the Braille characters 40 corresponding to the function buttons “6”, “7”, “8”, “9” and by following the embossed line 14b the Braille characters 40 corresponding to the function buttons “0”, “1”, “2”, “3”, “4”. The embossed line 18 leads, for its part, to the Braille characters 33 (33a, 33b) associated with the personalized function buttons 50 (50a, 50b). The area marked with a dashed line 30 in FIG. 1 can be used e.g. for presenting to sighted people function buttons and information related to call-giving.

If a visually impaired person wants to travel e.g. to the parking floor, he/she moves to the call panel 1 and seeks the embossed circle 13a on the call panel. Since the embossed circle 13a is situated on the touch-sensitive display 2 essentially in the bottom right-hand corner of the touch-sensitive display 2, a visually impaired person easily finds it by feeling the area on the right at the bottom of the touch-sensitive display. When the visually impaired person has found the embossed circle 13a, he/she starts to follow the embossed line 17 going to the left from the embossed circle 13a. At the branching point X of the embossed line 17 the visually impaired person starts to follow the embossed line 18, by following which he/she finds the text 33a, e.g. “PARKING”, formed by the Braille characters, indicating the car park. The visually impaired person moves his/her finger to the function button 50a associated with the text “PARKING”, which function button according to FIG. 1 is situated above the text 33a. Pressing or touching the function button 50a generates for the elevator system a destination call to the car parking level. The elevator system allocates an elevator car for the use of the visually impaired person and announces the allocated elevator car e.g. auditively with audio means (not presented in FIG. 1) that are in connection with the call panel 1.

If a visually impaired person wants to travel e.g. to floor 15, he/she moves to the call panel 1 and seeks the embossed circle 13a on the call panel. When the visually impaired person has found the embossed circle 13a, he/she starts to follow the embossed line 17 going to the left from the embossed circle 13a. At the branching point X of the embossed line 17 the visually impaired person starts to follow the embossed line 16, by following which he/she finds the Braille character 40a associated with the function button 20a (call pushbutton “5”) and onwards by following the embossed line 14b the Braille character 40b associated with the function button 20b (call pushbutton “1”). The visually impaired person presses or touches the call pushbutton “1” after finding the Braille character 40b, returns by feeling the embossed line 14b back to the Braille character 40a and presses the call pushbutton “5” (function button 20a) associated with it, in which case a destination call to floor 15 is generated for the elevator system.

Inside the embossed circle 13a is a function button 13b, pressing or touching which activates a special visual impairment mode, in which the functions of the call panel 1 are optimized for a user with impaired vision. In the visual impairment mode the call-giving panel can auditively guide a visually impaired user of the call panel, e.g. when the user touches the text 33a formed by Braille characters, the call-giving panel gives the auditive message “parking”.

The function buttons 50, 20 of the call panel can be framed with embossed lines to make it easier to find the function buttons.

The call panel according to FIG. 1 can be manufactured by printing with a 3D printer the necessary embossings onto the surface of the touch-sensitive display 2. The printing can take place onto the touch-sensitive display 2 before fixing the touch-sensitive display 2 to the call panel 1, which considerably facilitates the manufacturing of the call panel. A layout file, specifying the layout of the desired embossing, is formed for 3D printing. The file can be a file made e.g. with CAD software and the file can be made by the call panel manufacturer, end customer or some other party. The file is delivered to an embossing manufacturer who has 3D printing apparatus suited to the purpose.

The touch-sensitive display 2 can be a fixed part of the call-giving panel 1 or it can be easily detached and replaced with a new one without breaking the fixing elements of the touch-sensitive display. Replaceability enables easy changing of the embossing layout in call panels that have already been installed. For example, if changes affecting the layout occur in a building, a new embossing can be printed onto a new touch-sensitive display and the old touch-sensitive display of a call panel can be replaced with the new touch-sensitive display. Since the shape and size of embossings are not limited, but instead can be designed freely, a call panel can easily be personalized to be specific to a building, even to be specific to floor.

The size of the embossing must be adequate for a visually impaired person to feel the embossing with his/her fingertip with ease and to read e.g. the Braille characters. The embossed lines are e.g. 0.2 mm . . . 4 mm in width and 0.1 mm . . . 2 mm in height. It is also possible to print with a 3D printer a membrane onto the touch-sensitive display, said membrane having apertures at least at the point of the function buttons. Printing embossings onto the aforementioned membrane produces a strong structure and fixing surface for the embossings. Preferably UV light (ultraviolet light) is used for curing the ink in printing embossings. The color of the ink can be changed, if necessary also during the printing, enabling color coding of the embossings for sighted users. In this case e.g. the embossings 18, 33 associated with personalized function buttons can be printed with a first color and the other embossings with some other color. Color coding makes it easier for sighted passengers to give calls. If the embossings are printed with transparent ink, the color of any embossing whatsoever, or of a part of any embossing whatsoever, can be changed dynamically by dynamically changing the color of that part of the touch-sensitive display under the embossing.

The touch-sensitive display 2 is preferably a capacitive touch-sensitive display.

The invention is not only limited to be applied to the embodiments described above, but instead many variations are possible within the scope of the inventive concept defined by the claims.

1. A call panel of an elevator system, the call panel comprising:
at least one touch-sensitive display,
wherein on the surface of the touch-sensitive display is a plurality of embossed marks, embossed lines connecting the embossed marks, and at least one function button associated with at least one of the plurality of embossed marks.

2. The call panel according to claim 1, wherein in at least one corner of the call panel is the starting point of at least one of the embossed lines, and by following the embossed line, at least one of the plurality of embossed marks can be found.

3. The call panel according to claim 1, wherein the function button is essentially above the one or more embossed marks designating the function button.

4. The call panel according to claim 1, wherein the call panel comprises one or more Braille characters from the plurality 0, 1, 2 . . . 9 with function buttons for giving destination calls.

5. The call panel according to claim 1, wherein the call panel comprises one or more personalized function buttons, associated with which is one or more embossed marks designating the function button.

6. The call panel according to claim 1, wherein the touch-sensitive display can be detached and replaced with another touch-sensitive display without breaking the fixing of the touch-sensitive display.

7. A method for manufacturing a call panel of an elevator system, which call panel comprises at least one touch-sensitive display, said method comprising the step of:
printing a plurality of embossed marks and embossed lines connecting them with a 3D printer onto the surface of a touch-sensitive display according to a desired layout.

8. The method according to claim 7, wherein ink cured with UV light is used for printing the embossings.

9. The method according to claim 7, wherein in the printing of the embossings at least one ink is used with which the printed embossings are essentially colored.

10. The method according to claim 7, wherein in the printing of the embossings an ink is used with which the printed embossings are essentially transparent.

11. The method according to claim 7, wherein at least a part of the embossed lines are printed as dashed lines.

12. The call panel according to claim 2, wherein the function button is essentially above the one or more embossed marks designating the function button.

13. The call panel according to claim 2, wherein the call panel comprises one or more Braille characters from the plurality 0, 1, 2 . . . 9 with function buttons for giving destination calls.

14. The call panel according to claim 3, wherein the call panel comprises one or more Braille characters from the plurality 0, 1, 2 . . . 9 with function buttons for giving destination calls.

15. The call panel according to claim 2, wherein the call panel comprises one or more personalized function buttons, associated with which is one or more embossed marks designating the function button.

16. The call panel according to claim 3, wherein the call panel comprises one or more personalized function buttons, associated with which is one or more embossed marks designating the function button.

17. The call panel according to claim 4, wherein the call panel comprises one or more personalized function buttons, associated with which is one or more embossed marks designating the function button.

18. The call panel according to claim 2, wherein the touch-sensitive display can be detached and replaced with another touch-sensitive display without breaking the fixing of the touch-sensitive display.

19. The call panel according to claim 3, wherein the touch-sensitive display can be detached and replaced with another touch-sensitive display without breaking the faille of the touch-sensitive display.

20. The call panel according to claim 4, Wherein the touch-sensitive display can be detached and replaced with another touch-sensitive display without breaking the fixing of the touch-sensitive display.
